(19) United States
(12) Patent Application Publication
(10) Pub. No.: US 2013/0097517 A1
(43) Pub. Date: Apr. 18, 2013

(54) Permission Control for Applications

(71) Applicants: David Scott Reiss, Mountain View, CA (US); Matthew Nicholas Papakipos, Palo Alto, CA (US); Sara Marie Golemon, San Jose, CA (US)

(72) Inventors: David Scott Reiss, Mountain View, CA (US); Matthew Nicholas Papakipos, Palo Alto, CA (US); Sara Marie Golemon, San Jose, CA (US)

(21) Appl. No.: 13/276,201

(22) Filed: Oct. 18, 2011

(51) Int. Cl. G06F 3/00

(52) U.S. Cl. 715/741

(57) ABSTRACT

In one embodiment, methods and systems enabling a user to control access by an application to one or more hardware components of a user's client device and to user data stored remotely and/or locally on the user's client device.

### TECHNICAL FIELD

This disclosure generally relates to enabling a user to control access by an application to one or more hardware components of a user's client device and to user data stored remotely and/or locally on the user's client device.

### BACKGROUND

Within a client-server environment, a client may receive services from a server over a computer network. Examples of the client devices include, but not limited to, desktop computers, notebook computers, netbook computers, smart phones, personal digital assistants (PDA), tablets, etc. These clients are able to connect to a computer or communications network, such as the Internet or a mobile telephone network, and access and communicate with the servers that are also connected to the network using various suitable communications protocols. A client is thus able to transmit data to and receive data from a server over the network.

In addition, users may install a variety of native applications and/or web-based applications on a computing device (such as smartphones, netbooks, and the like) that access one or more sensors or other input/output devices of the computing device (such as Global Positioning System (GPS) chips, cameras, accelerometers, and the like) and provide services to users.

### SUMMARY

This disclosure generally relates to enabling a user to control access by an application to one or more hardware components of a user's client device and to user data stored remotely and/or locally on the user's client device.

In particular embodiments, a computing device associated with a user, in response to the user attempting to interact with an application, presents to the user a permissions interface requesting permission to run the application on the computing device. The permissions interface comprises a list that includes one or more hardware components of the computing device, one or more user data elements associated with the user stored on the computing device or remotely from the computing device at one or more remote hosts that the application requests access. The computing device receives a response from the user with respect to the list; and if the response grants the application access to the hardware and data resources identified on the list, then grants the application access to those resources. In one implementation, the computer device transmits the user's authorization to the one or more remote hosts to allow such remote hosts to receive indication of such authorization and thereafter allow future access requests transmitted by the application executed on the computer device. In some implementations, the data resources associated with the user may be social network data, such as user profile data associated with the user including but not limited to user contact information, contact information, pictures, and other multimedia associated with the user.

These and other features, aspects, and advantages of the disclosure are described in more detail below in the detailed description and in conjunction with the following figures.

### BRIEF DESCRIPTION OF THE DRAWINGS

FIG. 1 illustrates an example system that various implementations of the invention can be integrated with.

FIG. 2 illustrates an example client device.

FIG. 3 illustrates an example method for controlling an application's access to a user data and client device hardware resources.

FIG. 4 illustrates an example network environment.

FIG. 5 illustrates an example computer system.

### DESCRIPTION OF EXAMPLE EMBODIMENTS

This disclosure is now described in detail with reference to a few embodiments thereof as illustrated in the accompanying drawings. In the following description, numerous specific details are set forth in order to provide a thorough understanding of this disclosure. However, this disclosure may be practiced without some or all of these specific details. In other instances, well known process steps and/or structures have not been described in detail in order not to unnecessarily obscure this disclosure. In addition, while the disclosure is described in conjunction with the particular embodiments, it should be understood that this description is not intended to limit the disclosure to the described embodiments. To the contrary, the description is intended to cover alternatives, modifications, and equivalents as may be included within the spirit and scope of the disclosure as defined by the appended claims.

Particular embodiments enable a user to control access of an application to one or more hardware components of a user's client device and to user data stored locally on the user's client device and/or remotely on one or more remote hosts, such as a social networking system. In particular embodiments, the application hosted on the user's client device is a web-based application or a native application. In particular embodiments, the remote host (e.g., a social-networking website or system) may store data corresponding to, or otherwise associated with, the user. In some implementations, the data may be associated with a user account defining access privileges to the data by other users and/or applications (either created or associated with the remote host or third parties). Some implementations of the invention allow any number of applications hosted and/or executed on a client device of a user to seamlessly access hardware resources and data resources (local and/or remote). When a user wishes to use an application, particular embodiments enable the user to specify access permission on whether the application may access and use the user's client device (e.g., specific hardware components included in the client device) through which the user accesses and interacts with the application and/or the user's personal information (e.g., the user data), which may be stored on the user's client device itself or in a remote database (e.g., a database managed by a remote host, like a social network system). In particular embodiments, a user only needs to specify the access permission for a given application the first time the user uses that application.

Within a client-server environment, a client may transmit data to and receive data from a server over a computer or communications network. There are many types of client devices, such as, for example and without limitation, desktop computers, notebook computers, netbook computers, mobile telephones, smart phones, tablets, and other handheld electronic devices. Some of these client devices have wired network connections and some have wireless network connections. They are capable of communicating with other devices over one or more types of networks using various suitable communications protocols.

A user of a client device may use and interact with software applications through the client device. In general, there are two categories of software applications: native applications and web-based applications. A native application typically is one that resides and executes on the client device itself (e.g., within the environment provided by the operating system of the client device). A native application usually needs to be installed on a client device before it may be executed on that client device, and executes within the context of an operating system of the client device. In contrast, a web-based application typically is one that executes within the context of a browser client or other software that utilizes a browser engine (such as webkit). The web-based application usually provides a web-based user interface, which may be accessed by the client device (e.g., through a web browser executing on the client device), and a user of the client device may interact with the web-based application through this web-based user interface.

There are many types of web-based applications. Indeed, almost any native application (e.g., email client, word processor, an address book, an instant messaging client, a spreadsheet application, and the like) can be implemented as a web-based application. An example web-based application may involve a social-networking system hosting a social-networking website that transmits structured documents (e.g., HTML pages) with references to one or more code modules that are operative to execute within the context of a browser client. A social network, in general, is a social structure made up of entities, such as individuals or organizations, that are connected by one or more types of interdependency or relationships, such as friendship, kinship, common interest, financial exchange, dislike, or relationships of beliefs, knowledge, or prestige. In more recent years, social networks have taken advantage of the Internet. There are social-networking systems existing on the Internet in the form of social-networking websites. Such social-networking websites enable their members, who are commonly referred to as website users, to perform various social activities. For example, the social-networking website operated by Facebook, Inc. at www.facebook.com enables its users to communicate with their friends via emails, instant messages, or blog postings, organize social events, share photos, receive news of their friends or interesting events, play games, etc.

In general, a web-based application may provide any number of services or functionalities to its users. For example, as described above, a social-networking website may enable its users to perform various social activities, such as establishing social connections, communicating with other users, posting messages, sharing photos, organizing social events, etc. As discussed herein, the user data resources associated with a first web-based application (e.g., user profile data of a social network application) can be accessed by other applications. For example, other web-based applications provided by third parties (relative to the social networking system) may offer additional services or functionalities provided by the third-party applications. For example, in part by accessing data of a social network system, its users may play computer games provided by various third-party applications (e.g., a Facebook user may play games provided by Zynga, Inc. through his/her Facebook user account). For clarification purposes, hereafter, a first web-based application and its associated user data resources corresponding to a given user is referred to as the “first-party” application (in contrast to the third-party applications).

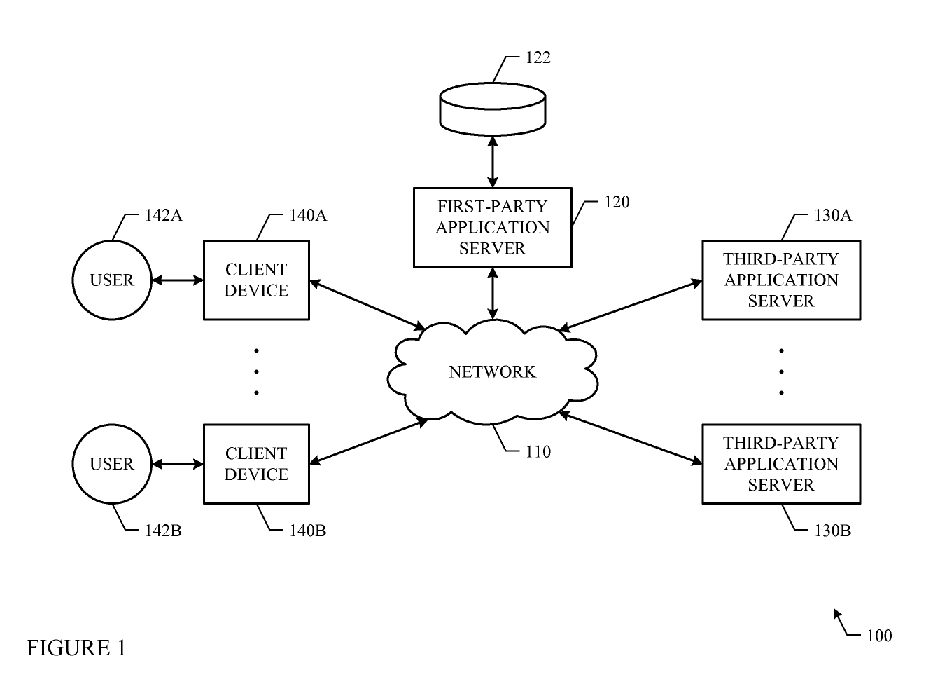

FIG. 1 illustrates an example system 100 that includes a first-party application 120, a number of third-party application servers 130 (e.g., third-party application servers 130A, 130B), and a number of client devices 140 respectively associated with a number of users 142 (e.g., user 142A is associated with client device 140A, and user 142B is associated with client device 140B). In particular embodiments, first-party application server 120 and third-party application server 130 may each interact with a web-based application hosted on the one or more client devices 140. In particular embodiments, first-party application server 120 is part of a social-networking system hosting a social-networking website. In particular embodiments, client devices 140 may each be connected to network 110 as well, such that a user 142 of first-party application server 120 may access any one of first-party and third-party application servers 120, 130 using an associated client device 140.

In particular embodiments, each user 142 may have his/her own user data maintained in connection with first-party application server 120. In particular embodiments, a user's (e.g., user 142A or 142B) user data may include any data or information provided by or associated with the user. Examples of user data may include, but not limited to, a user's username, password, email addresses, phone numbers, physical addresses, demographic information (e.g., age, gender, education, profession, income level, marital status, etc.), user account settings (e.g., security questions and answers, security settings, privacy settings, etc.), social connections, social groups, social events, shared files (e.g., photos, videos, audios, etc.), posted messages (e.g., blogs, comments, etc.), subscriptions (e.g., news feeds, notifications, etc.), interests, hobbies, and so on.

In particular embodiments, some or all of a user's user data may be stored in a data store 122 (e.g., a database or a cloud storage) connected to and managed by first-party application server 120. In particular embodiments, some or all of a user's user data may be stored on a client device associated with the user (e.g., some of the user data of user 142A are stored on client device 140A, and some of the user data of user 142B are stored on client device 140B). Note that some user data may be stored both in data store 122 and on a client device 140 associated with a user 142, and some user data may be stored only in data store 122 or only on a client device 140 associated with a user 142. For clarification purposes, hereafter, the user data stored in data store 122 are referred to as “remote” user data, whereas the user data stored on a client device 140 are referred to as “local” user data. Note that “remote” and “local” are determined relative to a client device of the user.

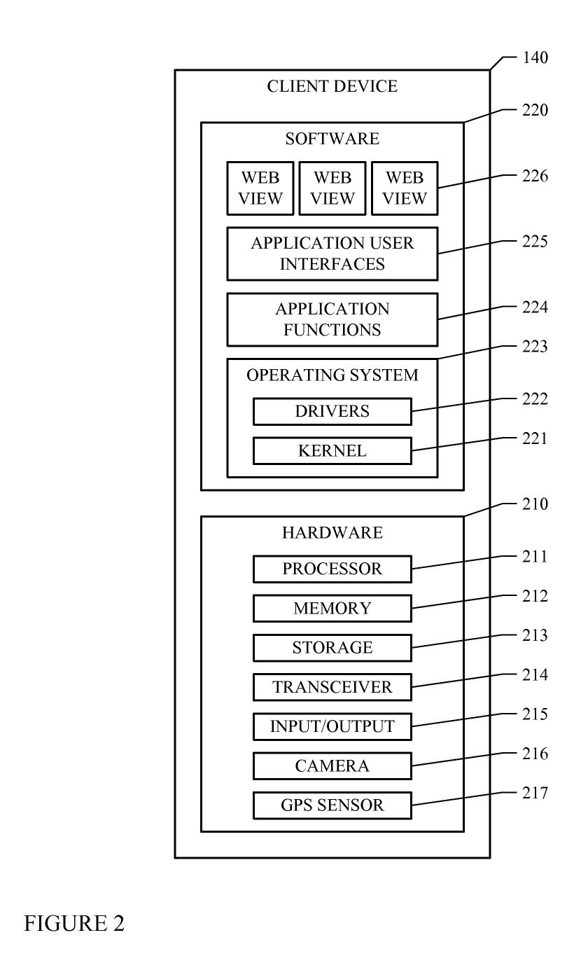

In particular embodiments, a client device 140 may include hardware, firmware, and software. FIG. 2 illustrates an example client device 140. In particular embodiments, client device 140 may be a smart phone (e.g., iPhone or Blackberry), which is a mobile telephone that offers more advanced computing ability and connectivity than a traditional mobile phone. It may be considered as a handheld computer integrated with a mobile phone. In particular embodiments, client device 140 may be a netbook or tablet computer (e.g., iPad). In particular embodiments, client device 140 may be connected to network 110 through a wireless connection.

In particular embodiments, client device 140 may include hardware 210 and software 220. In particular embodiments, hardware 210 may include any number of hardware components such as, for example and without limitation, processor 211, memory 212, storage 213, transceiver 214, input/output device 215 (e.g., display, keypad, microphone, speaker, etc.), camera 216, global positioning system (GPS) sensor 217, and so on. This disclosure contemplates any suitable hardware components. In particular embodiments, some or all of a user's user data may be stored in storage 213.

In particular embodiments, software 220 may include an operating system 223, which may include a kernel 221 and/or any number of device drivers 222 corresponding to some of the hardware components available on client device 140. Operating system 223 may be selected for client device 140 based on the actual type of device client device 140 is. For example, if client device 140 is a mobile device (e.g., a smart phone), then operating system 223 may be a mobile operating system such as, for example and without limitation, Microsoft's Windows Mobile, Google's Android, Nokia's Symbian, Apple's iOS, and Samsung's Bada.

In particular embodiments, one or more software applications may be executed on client device 140. In particular embodiments, they may be native or web-based applications installed and residing on client device 140. Thus, in particular embodiments, software 220 may also include any number of application functions 224 and application user interfaces 225. For example, one application (e.g., Google Maps) may enable a device user to view a map, search for addresses and businesses, and get directions; a second application may enable the device user to read, send, and receive emails; a third application (e.g., a web browser) may enable the device user to browse and search the Internet; a fourth application may enable the device user to take photos or record videos using camera 216; a fifth application may allow the device user to receive and initiate VoIP and/or cellular network calls, and so on. Each software application has one or more specific functionalities, and the software (e.g., one or more software modules) implementing these functionalities may be included in application functions 224. Each software application may also implement a user interface that enables the device user to interact with the application, and the software implementing the application user interface may be included in application user interfaces 225. In particular embodiments, the functionalities of an application may be implemented using JavaScript, Java, C, or other suitable programming languages. In particular embodiments, the user interface of an application may be implemented using HyperText Markup Language (HTML), JavaScript, Java, or other suitable programming languages.

In particular embodiments, the user interface of a software application may include any number of screens or displays. In particular embodiments, each screen or display of the user interface may be implemented as a web page. Thus, the device user may interact with the application through a series of screens or displays (i.e., a series of web pages). In particular embodiments, operating system 223 is Google's Android. With Android, there is a Java package called “android.webkit”, which provides various tools for browsing the web. Among the “android.webkit” package, there is a Java class called “android.webkit.WebView”, which implements a View for displaying web pages. This Java class uses the WebKit rendering engine to display web pages and includes methods to navigate forward and backward through a history, zoom in, zoom out, perform text searches, and so on. In particular embodiments, an application user interface 225 may utilize Android's WebView application programming interface (API) to display each web page of the user interface in a View implemented by the “android.webkit.WebView” class. Thus, in particular embodiments, software 220 may include any number of web views 226, each for displaying one or more web pages that implement the user interface of an application. Some web views 226 may be associated with or provided by first party application server 120, while other web views 226 may be associated with or provided by one or more of the third party application servers 130. In some implementations, the user interface descriptions and the executable code of each software may be hosted (fully or partially) on the client device 140 of the user. In some implementations, some of the user interface data and executable code objects may be hosted on application servers 120, 130 and transmitted to client device 140 in connection with one or more web views 226.

During the execution of a software application, the device user may interact with the application through its user interface. For example, the user may provide inputs to the application in various web view displays (e.g., web pages). Outputs of the application may be presented to the user in various displays (e.g., web pages) as well. In particular embodiments, when the user provides an input to the application through a specific display (e.g., a specific web page), an event (e.g., an input event) may be generated by, for example, a web view 226 or application user interfaces 225. Each input event may be forwarded to application functions 224, or application functions 224 may listen for input events thus generated. When application functions 224 receive an input event, the appropriate software module in application functions 224 may be invoked to process the event. In addition, specific functionalities provided by operating system 223 and/or hardware 210 may also be invoked. For example, if the event is generated as a result of the user pushing a button to take a photo with camera 216, a corresponding image processing module may be invoked to convert the raw image data into an image file (e.g., JPG or GIF) and store the image file in memory 212 or storage 213. As another example, if the event is generated as a result of the user selecting an icon to compose an instant message, the corresponding short message service (SMS) module may be invoked to enable the user to compose and send the message.

In particular embodiments, when an output of the application is ready to be presented to the user, an event (e.g., an output event) may be generated by, for example, a software module in application functions 224 or operating system 223. Each output event may be forwarded to application user interfaces 225, or application user interfaces 225 may listen for output events thus generated. When application user interfaces 225 receive an output event, it may construct a web view 226 to display a web page representing or containing the output. For example, in response to the user selecting an icon to compose an instant message, an output may be constructed that includes a text field that allows the user to input the message. This output may be presented to the user as a web page and displayed to the user in a web view 226 so that the user may type into the text field the message to be sent.

As described above, in particular embodiments, the software applications residing and executing on client device 140 may include a web browser (e.g., Microsoft Internet Explorer, Mozilla Firefox, or Google Chrome). A user of client device 140 may access and interact with a web-based application (e.g., any one of applications associated with or corresponding to first-party and third-party applications 120, 130 illustrated in FIG. 1) either through the web browser or a web view 226. In particular embodiments, the first-party and third-party application servers 120, 130 may each have a unique Uniform Resource Identifier (URI) or more specifically, a unique Uniform Resource Locator (URL). To access a specific first-party or third-party application, the user may input the URL associated with the first-party or third-party application in the web browser executing on client device 140. The user interface of the first-party or third-party application may include a number of web pages, which may be displayed in the web browser or a web view 226.

In particular embodiments, a given application (e.g., a web view application associated with first or third-party application servers 120, 130 illustrated in FIG. 1) hosted on a client device (e.g., client device 140A or 140B illustrated in FIG. 1) may desire, or need, to access and utilize some of the user's user data hosted by (or accessible through) the first-party application server 120 (e.g., the user's remote user data), user data stored locally on the client device 140, and/or some of the hardware components of the user's client device 140 in order to, for example, provide certain services or functionalities to the user. For example, suppose that a given application enables a user to play a social game with other users who are his/her connections in a social-networking system. Accordingly, the application may need to access the user's social-connection data accessible through first party application server 120. As another example, if the application tracks a user's current location and sends information about businesses near the user's current location to the client device 140 of the user, the application may need to access the GPS sensor (and/or other hardware resources) of the client device associated with the user.

In particular embodiments, the application may be hosted on the client device 140 and operate as a stand-alone application or a distributed application in connection with one or more of first and third-party application servers 120, 130, as illustrated in FIG. 1. For example, some or all of the components of the application may be installed and executed on a client device. In particular embodiments, the application (e.g., one that may be hosted partially or wholly on a client device) may be provided by the same entity that also provides the first-party application server 120. In other implementations, the application may be provided by a third party relative to the entity that provides the first-party application server 120.

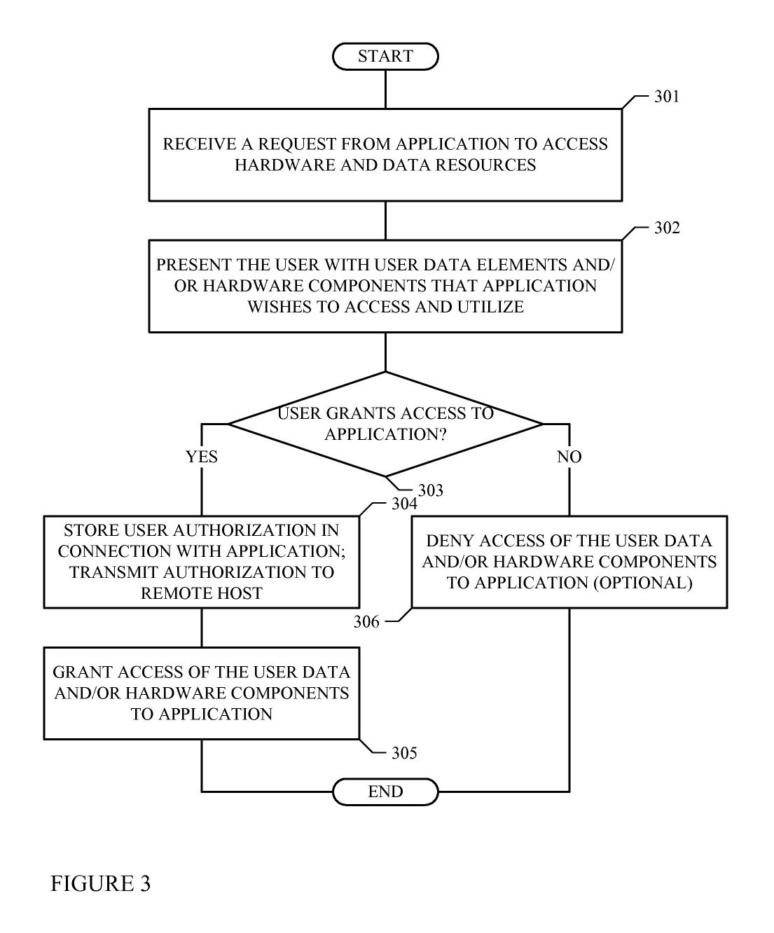

Particular embodiments enable a user to control access to his/her remote user data in connection with a web application (such and/or access to his/her client devices and device functionality by an application hosted or executed on client device 140. In particular embodiments, the application's access to the user's user data may include access to the user's local user data stored on the user's client devices, as well as the user's remote user data stored in a data store managed by the first-party application server 120. The application may also seek access to one or more sensors (or other hardware resources) of the client device, such as accelerometers, GPS sensors, cameras and the like. FIG. 3 illustrates an example method for controlling an application's access to a user's user data and client device resources.

In particular embodiments, an application hosted on or executing on a client device 140 may request access to user data resources associated with the user and/or hardware resources of the client device. In one implementation, the application may make one or more application programming interface (API) calls to a module or library hosted on client device 140 that implements the processes described below. In one implementation, when the user accesses the application hosted or executing on the user's client device, particular embodiments may receive a request from the application for access to remote and/or local data resources of the user and to hardware resources of the client device, as illustrated in STEP 301.

In particular embodiments, the application may seek to access some of the user data associated with or corresponding to the user that is maintained by (or otherwise accessible through) the first-party application server 120. In some implementations, the user data may include local user data stored on the user's client device and/or remote user data stored in a data stored managed by the first-party application server 120. In addition or alternatively, the application may desire to access some of the hardware components of the user's client device. In particular embodiments, each application may maintain a list of the specific user data elements (e.g., including local and/or remote user data) of a user and/or the specific hardware components of a user's client device it desires to access when the user accesses the application hosted or executing on the client device. For example, the user data elements may include a profile picture of the user, a contact list of the user, interests, hobbies, address information and the like. The specific hardware components may include GPS sensors, accelerometers, tilt sensors, cameras, temperature sensors, storage sub-systems, and the like.

Suppose that the user has not yet granted permission to the application to access some of his/her user data (such as social network data) and/or some of the hardware components of his/her client device requested by the application. Particular embodiments may present the user with the specific user data elements (e.g., profile picture, first-degree contacts, interests, address data, etc.) of the user data resources (local and/or remote) and/or the specific hardware components of the user's client device that are requested by the application, as illustrated in STEP 302. For example, the application may pass the requested items of data and hardware resources in an API call. Again, the user data resources may include the local user data stored on the user's client device and/or the remote user data stored in the data store accessible by the first-party application server 120.

In particular embodiments, the user is given the option of either granting or denying the application access to the specific user data and/or the specific hardware components of the user's client device, as illustrated in STEP 303, in a single step. In particular embodiments, upon reviewing the specific user data of the user and/or the specific hardware components of the user's client device the application desires to access, the user may either grant or deny access to all the user data and/or hardware components requested by the application as a whole with a single user input (e.g., a single click of a button or icon). This way, the user does not need to grant or deny access to the specific user data and/or hardware components individually, and the user may control access by the application quickly and conveniently. Furthermore, implementations of the invention allow a user to grant access for an application to access social network data of the user and one or more sensors (or other components) of the client device in the same approval workflow.

If the user grants access to his/her user data (e.g., including local and/or remote user data) and/or the hardware components of his/her client device for the application (STEP 303—“YES”), particular embodiments may store the authorization in connection with the application locally on the client device so that subsequently, when the user accesses the same application again, it is not necessary to request access authorization from the user again, as illustrated in STEP 304. In particular embodiments, indications of the user authorization may also be transmitted from the client device 140 to, and stored by, the first-party application server 120 (e.g., in a data store managed by the first-party application). Accordingly, when the application makes remote calls to the first-party application server 120 for user data, the first-party application server 120 may access its own authorization data when responding to the request. Furthermore, the indication of authorization may cause the first-party application server 120 to add a web-version of the same application (that is hosted on client device 140) to the user's application accessible using a desktop or laptop computer. For example, the indication of authorization may cause the first-party application server 120 to add a social network game as an installed application to the social network account of the user.

The following table illustrates an example data structure for storing user authorization to one or more applications. In this example, each row of the table corresponds to an application to which the user has granted access authorization. Each application is identified by a unique identifier (the first column of the table). For example, the unique identifier assigned to each application may follow a standard naming convention or based on a public registry of application names registered by application providers. In other implementations, the application identifiers are arbitrary-assigned identifiers. In addition, each application may be associated with a domain or a URL (the second column of the table). The specific user data and/or user device components to which the user has granted the third-party application access are listed in connection with the third-party application (the third column of the table).

USER AUTHORIZATION TO APPLICATIONS

| Application | | |
|---|---|---|
| ID | Application Domain | Grant List |
| 1 | gamesite.com/game1/. . . | GPS sensor, profile picture, |
| | | first-hop social connections, . . . |
| . . . | . . . | . . . |
| n | . . . | . . . |

In some implementations, this table may be maintained at the client device 140 and a remote data store accessible through first-party application server 120. The two copies can be synchronized based on changes made by the user. In particular embodiments, there may be a timestamp associated with each application in the table so that the access authorization granted to a application by the user may expire after some period of time. Thereafter, if the user wishes to use the application again, the user may need to grant access authorization to the application again. This way, the user is given the chance of making a decision as to whether to grant access authorization to an application from time to time so that the user may make different choices as needed. From the application's point of view, the list of user data and/or user device components it needs may change from time to time as well, as new functionalities may be added to the application or existing functionalities may be modified. The application also has the chance of presenting a modified list of user data and/or user device components it needs to the user and asking for access permission from the user from time to time. Furthermore, the time stamps may be used to synchronize access permission configurations between a user's mobile device and those configurations entered while accessing a first-party application hosted by first party application server 120 using a personal computer or other device.

After the user has granted access authorization to the application, particular embodiments may then give the application access to the specific user data and/or user device components so that the user may interact with and use the application, as illustrated in STEP 305. In particular embodiments, the application is only given access to the specific user data and/or user device components that the user has authorized. For example, if the user has authorized the application to access the GPS sensor on his/her smart phone but has not authorized the application to access the camera on his/her smart phone, then the application is only given access to the GPS sensor but not the camera on the user's smart phone.

For example, suppose that an application has been granted access to one or more of a user's remote user data and local user data and one or more of the hardware components of the user's client device. In particular embodiments, the first-party application server 120 may manage and control the application's access to the user's remote user data and ensure that only the specific remote user data that the application has access permission are accessible to the application. In particular embodiments, one or more software modules residing and executing on the user's client device may manage and control the application's access to the user's local user data and the hardware components of the client device and ensure that only the specific local user data and hardware components that the application has access permission are accessible to the application.

On the other hand, if the user denies access to his/her user data (e.g., including local and/or remote user data) and/or the hardware components of his/her client device by the application (STEP 303—“NO”), particular embodiments may notify the application that the user has denied its request to access the specific user data and/or user device components of the user and not give the application access to the specific user data and/or user device components it needs, as illustrated in STEP 306. Since the application cannot have access to the specific user data and/or user device components it needs, the user may not be able to use the application or specific functions or features of the application.

If the user denies access to his/her user data and/or the hardware components of his/her client device by the application, particular embodiments may store the denial in connection with the application for the user (e.g., put the application on a black list for the user). Subsequently, when the user accesses the same application again, particular embodiments may remind the user that the user has once denied access to his/her user data and/or user device components by this application. However, the user may be given the option to change his/her mind and grant access permission to the application.

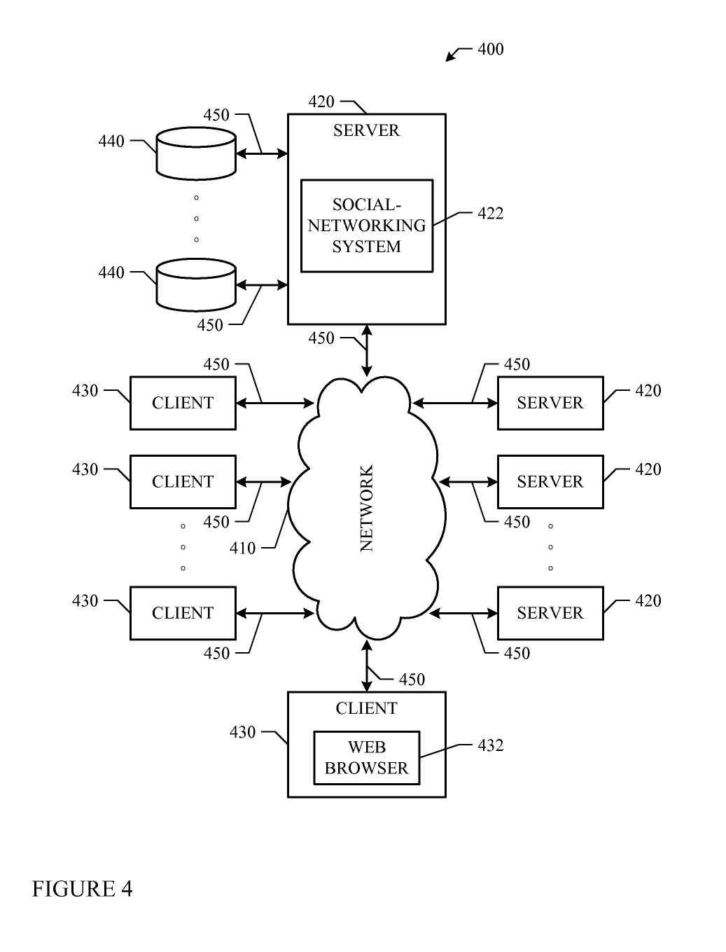

Particular embodiments may be implemented in a network environment. FIG. 4 illustrates an example network environment 400. Network environment 400 includes a network 410 coupling one or more servers 420 and one or more clients 430 to each other. In particular embodiments, network 410 is an intranet, an extranet, a virtual private network (VPN), a local area network (LAN), a wireless LAN (WLAN), a wide area network (WAN), a metropolitan area network (MAN), a portion of the Internet, or another network 410 or a combination of two or more such networks 410. This disclosure contemplates any suitable network 410.

One or more links 450 couple a server 420 or a client 430 to network 410. In particular embodiments, one or more links 450 each includes one or more wireline, wireless, or optical links 450. In particular embodiments, one or more links 450 each includes an intranet, an extranet, a VPN, a LAN, a WLAN, a WAN, a MAN, a portion of the Internet, or another link 450 or a combination of two or more such links 450. This disclosure contemplates any suitable links 450 coupling servers 420 and clients 430 to network 410.

In particular embodiments, each server 420 may be a unitary server or may be a distributed server spanning multiple computers or multiple datacenters. Servers 420 may be of various types, such as, for example and without limitation, web server, news server, mail server, message server, advertising server, file server, application server, exchange server, database server, or proxy server. In particular embodiments, each server 420 may include hardware, software, or embedded logic components or a combination of two or more such components for carrying out the appropriate functionalities implemented or supported by server 420. For example, a web server is generally capable of hosting websites containing web pages or particular elements of web pages. More specifically, a web server may host HTML files or other file types, or may dynamically create or constitute files upon a request, and communicate them to clients 430 in response to HTTP or other requests from clients 430. A mail server is generally capable of providing electronic mail services to various clients 430. A database server is generally capable of providing an interface for managing data stored in one or more data stores. In particular embodiments, a social-networking system 422 may be hosted on a server 420.

In particular embodiments, one or more data storages 440 may be communicatively linked to one or more severs 420 via one or more links 450. In particular embodiments, data storages 440 may be used to store various types of information. In particular embodiments, the information stored in data storages 440 may be organized according to specific data structures. In particular embodiments, each data storage 440 may be a relational database. Particular embodiments may provide interfaces that enable servers 420 or clients 430 to manage, e.g., retrieve, modify, add, or delete, the information stored in data storage 440.

In particular embodiments, each client 430 may be an electronic device including hardware, software, or embedded logic components or a combination of two or more such components and capable of carrying out the appropriate functionalities implemented or supported by client 430. For example and without limitation, a client 430 may be a desktop computer system, a notebook computer system, a netbook computer system, a handheld electronic device, or a mobile telephone. This disclosure contemplates any suitable clients 430. A client 430 may enable a network user at client 430 to access network 430. A client 430 may enable its user to communicate with other users at other clients 430.

A client 430 may have a web browser 432, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client 430 may enter a Uniform Resource Locator (URL) or other address directing the web browser 432 to a server 420, and the web browser 432 may generate a Hyper Text Transfer Protocol (HTTP) request and communicate the HTTP request to server 420. Server 420 may accept the HTTP request and communicate to client 430 one or more Hyper Text Markup Language (HTML) files responsive to the HTTP request. Client 430 may render a web page based on the HTML files from server 420 for presentation to the user. This disclosure contemplates any suitable web page files. As an example and not by way of limitation, web pages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web page encompasses one or more corresponding web page files (which a browser may use to render the web page) and vice versa, where appropriate.

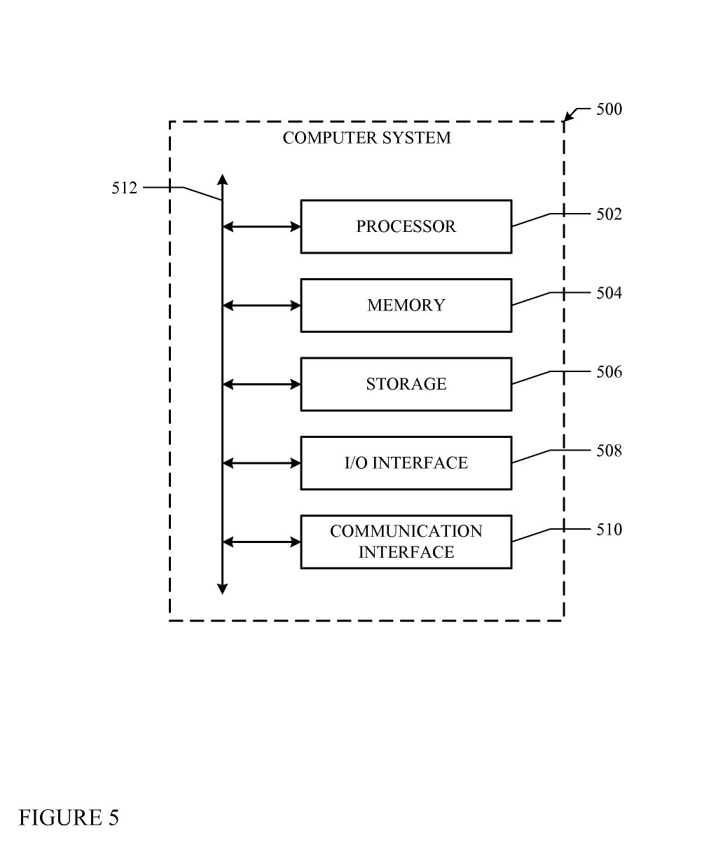

Particular embodiments may be implemented on one or more computer systems. FIG. 5 illustrates an example computer system 500. In particular embodiments, one or more computer systems 500 perform one or more steps of one or more methods described or illustrated herein. In particular embodiments, one or more computer systems 500 provide functionality described or illustrated herein. In particular embodiments, software running on one or more computer systems 500 performs one or more steps of one or more methods described or illustrated herein or provides functionality described or illustrated herein. Particular embodiments include one or more portions of one or more computer systems 500.

This disclosure contemplates any suitable number of computer systems 500. This disclosure contemplates computer system 500 taking any suitable physical form. As example and not by way of limitation, computer system 500 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, computer system 500 may include one or more computer systems 500; be unitary or distributed; span multiple locations; span multiple machines; or reside in a cloud, which may include one or more cloud components in one or more networks. Where appropriate, one or more computer systems 500 may perform without substantial spatial or temporal limitation one or more steps of one or more methods described or illustrated herein. As an example and not by way of limitation, one or more computer systems 500 may perform in real time or in batch mode one or more steps of one or more methods described or illustrated herein. One or more computer systems 500 may perform at different times or at different locations one or more steps of one or more methods described or illustrated herein, where appropriate.

In particular embodiments, computer system 500 includes a processor 502, memory 504, storage 506, an input/output (I/O) interface 508, a communication interface 510, and a bus 512. Although this disclosure describes and illustrates a particular computer system having a particular number of particular components in a particular arrangement, this disclosure contemplates any suitable computer system having any suitable number of any suitable components in any suitable arrangement.

In particular embodiments, processor 502 includes hardware for executing instructions, such as those making up a computer program. As an example and not by way of limitation, to execute instructions, processor 502 may retrieve (or fetch) the instructions from an internal register, an internal cache, memory 504, or storage 506; decode and execute them; and then write one or more results to an internal register, an internal cache, memory 504, or storage 506. In particular embodiments, processor 502 may include one or more internal caches for data, instructions, or addresses. This disclosure contemplates processor 502 including any suitable number of any suitable internal caches, where appropriate. As an example and not by way of limitation, processor 502 may include one or more instruction caches, one or more data caches, and one or more translation lookaside buffers (TLBs). Instructions in the instruction caches may be copies of instructions in memory 504 or storage 506, and the instruction caches may speed up retrieval of those instructions by processor 502. Data in the data caches may be copies of data in memory 504 or storage 506 for instructions executing at processor 502 to operate on; the results of previous instructions executed at processor 502 for access by subsequent instructions executing at processor 502 or for writing to memory 504 or storage 506; or other suitable data. The data caches may speed up read or write operations by processor 502. The TLBs may speed up virtual-address translation for processor 502. In particular embodiments, processor 502 may include one or more internal registers for data, instructions, or addresses. This disclosure contemplates processor 502 including any suitable number of any suitable internal registers, where appropriate. Where appropriate, processor 502 may include one or more arithmetic logic units (ALUs); be a multi-core processor; or include one or more processors 502. Although this disclosure describes and illustrates a particular processor, this disclosure contemplates any suitable processor.

In particular embodiments, memory 504 includes main memory for storing instructions for processor 502 to execute or data for processor 502 to operate on. As an example and not by way of limitation, computer system 500 may load instructions from storage 506 or another source (such as, for example, another computer system 500) to memory 504. Processor 502 may then load the instructions from memory 504 to an internal register or internal cache. To execute the instructions, processor 502 may retrieve the instructions from the internal register or internal cache and decode them. During or after execution of the instructions, processor 502 may write one or more results (which may be intermediate or final results) to the internal register or internal cache. Processor 502 may then write one or more of those results to memory 504. In particular embodiments, processor 502 executes only instructions in one or more internal registers or internal caches or in memory 504 (as opposed to storage 506 or elsewhere) and operates only on data in one or more internal registers or internal caches or in memory 504 (as opposed to storage 506 or elsewhere). One or more memory buses (which may each include an address bus and a data bus) may couple processor 502 to memory 504. Bus 512 may include one or more memory buses, as described below. In particular embodiments, one or more memory management units (MMUs) reside between processor 502 and memory 504 and facilitate accesses to memory 504 requested by processor 502. In particular embodiments, memory 504 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 504 may include one or more memories 504, where appropriate. Although this disclosure describes and illustrates particular memory, this disclosure contemplates any suitable memory.

In particular embodiments, storage 506 includes mass storage for data or instructions. As an example and not by way of limitation, storage 506 may include an HDD, a floppy disk drive, flash memory, an optical disc, a magneto-optical disc, magnetic tape, or a Universal Serial Bus (USB) drive or a combination of two or more of these. Storage 506 may include removable or non-removable (or fixed) media, where appropriate. Storage 506 may be internal or external to computer system 500, where appropriate. In particular embodiments, storage 506 is non-volatile, solid-state memory. In particular embodiments, storage 506 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 506 taking any suitable physical form. Storage 506 may include one or more storage control units facilitating communication between processor 502 and storage 506, where appropriate. Where appropriate, storage 506 may include one or more storages 506. Although this disclosure describes and illustrates particular storage, this disclosure contemplates any suitable storage.

In particular embodiments, I/O interface 508 includes hardware, software, or both providing one or more interfaces for communication between computer system 500 and one or more I/O devices. Computer system 500 may include one or more of these I/O devices, where appropriate. One or more of these I/O devices may enable communication between a person and computer system 500. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 508 for them. Where appropriate, I/O interface 508 may include one or more device or software drivers enabling processor 502 to drive one or more of these I/O devices. I/O interface 508 may include one or more I/O interfaces 508, where appropriate. Although this disclosure describes and illustrates a particular I/O interface, this disclosure contemplates any suitable I/O interface.

In particular embodiments, communication interface 510 includes hardware, software, or both providing one or more interfaces for communication (such as, for example, packet-based communication) between computer system 500 and one or more other computer systems 500 or one or more networks. As an example and not by way of limitation, communication interface 510 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 510 for it. As an example and not by way of limitation, computer system 500 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 500 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 500 may include any suitable communication interface 510 for any of these networks, where appropriate. Communication interface 510 may include one or more communication interfaces 510, where appropriate. Although this disclosure describes and illustrates a particular communication interface, this disclosure contemplates any suitable communication interface.

In particular embodiments, bus 512 includes hardware, software, or both coupling components of computer system 500 to each other. As an example and not by way of limitation, bus 512 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or another suitable bus or a combination of two or more of these. Bus 512 may include one or more buses 512, where appropriate. Although this disclosure describes and illustrates a particular bus, this disclosure contemplates any suitable bus or interconnect.

Herein, reference to a computer-readable storage medium encompasses one or more non-transitory, tangible computer-readable storage media possessing structure. As an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. Herein, reference to a computer-readable storage medium excludes any medium that is not eligible for patent protection under 35 U.S.C. §101. Herein, reference to a computer-readable storage medium excludes transitory forms of signal transmission (such as a propagating electrical or electromagnetic signal per se) to the extent that they are not eligible for patent protection under 35 U.S.C. §101. A computer-readable non-transitory storage medium may be volatile, non-volatile, or a combination of volatile and non-volatile, where appropriate.

This disclosure contemplates one or more computer-readable storage media implementing any suitable storage. In particular embodiments, a computer-readable storage medium implements one or more portions of processor 502 (such as, for example, one or more internal registers or caches), one or more portions of memory 504, one or more portions of storage 506, or a combination of these, where appropriate. In particular embodiments, a computer-readable storage medium implements RAM or ROM. In particular embodiments, a computer-readable storage medium implements volatile or persistent memory. In particular embodiments, one or more computer-readable storage media embody software. Herein, reference to software may encompass one or more applications, bytecode, one or more computer programs, one or more executables, one or more instructions, logic, machine code, one or more scripts, or source code, and vice versa, where appropriate. In particular embodiments, software includes one or more application programming interfaces (APIs). This disclosure contemplates any suitable software written or otherwise expressed in any suitable programming language or combination of programming languages. In particular embodiments, software is expressed as source code or object code. In particular embodiments, software is expressed in a higher-level programming language, such as, for example, C, Perl, or a suitable extension thereof. In particular embodiments, software is expressed in a lower-level programming language, such as assembly language (or machine code). In particular embodiments, software is expressed in JAVA. In particular embodiments, software is expressed in Hyper Text Markup Language (HTML), Extensible Markup Language (XML), or other suitable markup language.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A method comprising: by a computing device associated with a user,
in response to a request associated with an application hosted on the computing device,
presenting in a user interface resource access data identifying one or more hardware components of the computing device and one or more elements of user data stored on a remote host;
receiving a response from the user with respect to the resource access data; and
responsive to an indication of a grant of access to the application, configuring the computing device to allow the application access to the one or more hardware components of the computing device and the one or more elements of user data stored on a remote host; and
transmitting the indication of the grant of access to the application to the remote host.

2. The method of claim 1, wherein the resource access data further comprises one or more second elements of user data stored in a data store maintained locally at the computing device.

3. The method of claim 1, wherein the one or more elements user data and the one or more second elements user data have been provided by the user.

4. The method of claim 2, wherein:
the application's access to the one or more elements of user data and the one or more hardware components is managed and controlled by a second application hosted by the computing device; and
the application's access to the one or more second elements of user data is managed and controlled by the remote host.

5. The method of claim 2, wherein the user interface provides a control element allowing the user to provide the response through a single input to the computing device.

6. The method of claim 1, further comprising if the response denies the application access, then denying the application access to the one or more hardware components of the computing device and the one or more elements of user data stored on a remote host.

7. The method of claim 1, further comprising if the response grants the application access to the one or more hardware components of the computing device and the one or more elements of user data stored on a remote host, then notifying the application that the user has granted the application access.

8. An apparatus, comprising:
a memory;
a network interface;
one or more processors;
a storage medium containing computer-readable instructions operable, when executed, to cause the apparatus and the one or more processors to:
in response to a request associated with an application hosted on the apparatus,
present, in a user interface, resource access data identifying one or more hardware components of the apparatus and one or more elements of user data stored on a remote host;
receiving a response from a user with respect to the resource access data; and
responsive to an indication of a grant of access to the application, configuring the computing device to allow the application access to the one or more hardware components of the apparatus and the one or more elements of user data stored on a remote host; and
transmitting the indication of the grant of access to the application to the remote host.

9. The apparatus of claim 8, wherein the resource access data further comprises one or more second elements of user data stored in a data store maintained locally at the apparatus.

10. The apparatus of claim 9, wherein the one or more elements user data and the one or more second elements user data have been provided by the user.

11. The apparatus of claim 9, wherein:
the application's access to the one or more elements of user data and the one or more hardware components is managed and controlled by a second application hosted by the apparatus; and
the application's access to the one or more second elements of user data is managed and controlled by the remote host.

12. The apparatus of claim 8, wherein the user interface provides a control element allowing the user to provide the response through a single input to the apparatus.

13. The apparatus of claim 8, wherein the storage medium further comprises instructions operative to cause the apparatus and the one or more processors to: if the response denies the application access, deny the application access to the one or more hardware components of the apparatus and the one or more elements of user data stored on a remote host.

14. The apparatus of claim 8, wherein the storage medium further comprises instructions operative to cause the apparatus and the one or more processors to: if the response grants the application access to the one or more hardware components of the apparatus and the one or more elements of user data stored on a remote host, notify the application that the user has granted the application access.

15. One or more non-transitory computer-readable storage media embodying logic that is operable when executed to:
in response to a request associated with an application hosted on a computing device associated with a user,
present in a user interface resource access data identifying one or more hardware components of the computing device and one or more elements of user data stored on a remote host;
receive a response from the user with respect to the resource access data; and
responsive to an indication of a grant of access to the application, configure the computing device to allow the application access to the one or more hardware components of the computing device and the one or more elements of user data stored on a remote host; and
transmit the indication of the grant of access to the application to the remote host.

16. The storage media of claim 15, wherein the resource access data further comprises one or more second elements of user data stored in a data store maintained locally at the computing device.

17. The storage media of claim 16, wherein the one or more elements user data and the one or more second elements user data have been provided by the user.

18. The storage media of claim 16, wherein:
the application's access to the one or more elements of user data and the one or more hardware components is managed and controlled by a second application hosted by the computing device; and
the application's access to the one or more second elements of user data is managed and controlled by the remote host.

19. The storage media of claim 15, wherein the user interface provides a control element allowing the user to provide the response through a single input to the computing device.

20. The storage media of claim 15, wherein the storage medium further comprises instructions operative to cause the apparatus and the one or more processors to: if the response denies the application access, deny the application access to the one or more hardware components of the computing device and the one or more elements of user data stored on a remote host.
